(19) United States
(12) Patent Application Publication
(10) Pub. No.: US 2008/0147471 A1
(43) Pub. Date: Jun. 19, 2008

(54) Topic based meeting scheduler

(75) Inventors: Ajay Kumar Singh, Rohini (IN); Madhu Syamala, Malleswaram (IN); Alok Srivastava, Moraga, CA (US)

Correspondence Address: EVERGREEN VALLEY LAW GROUP, P.C. AND;ORACLE INTERNATIONAL CORPORATION, 2670 SOUTH WHITE ROAD, SUITE 275, SAN JOSE, CA, 95148, US

(73) Assignee: Oracle International Corporation, Redwood Shores, CA (US)

(21) Appl. No.: 11/639,986

(22) Filed: Dec. 15, 2006

(30) Foreign Application Priority Data
Dec. 13, 2006 (IN) 2311/CHE/2006

(51) Int. Cl. G06Q 10/00

(52) U.S. Cl. 705/9

(57) ABSTRACT

The present invention discloses a method and system for scheduling topic based meetings. The method allows users to update their interests, profile, role etc., and the organizer of the meeting to define objective and agenda of the meeting, based on which the system intelligently assembles the set of users among whom the meeting has to be scheduled on a per topic basis. Once this set has been constructed, a regular scheduling algorithm is applied to arrange a meeting among the interested users. The scheduling process is distributed across various agents acting on behalf of the users among whom the meeting is arranged. Topic based meeting scheduler allows users with similar interests to schedule meetings based on common interests. The method and system of the present invention reduces the time in organizing the meeting among users required to attend, thus improving the efficiency of the group and making collaboration in an efficient manner.

### BACKGROUND OF THE INVENTION

1. Field of the Invention

The present invention generally relates to a meeting scheduling system and, in particular, to a method and system for scheduling a topic based meeting among a set of users.

2. Description of Related Art

One of the key difficulties in arranging topic-based meetings is in ensuring that everybody relevant to/interested in the meeting are considered when deciding on the meeting schedule. Current meeting schedulers though do not attempt to resolve this problem of finding the relevant audience for the meeting. Rather they concentrate on scheduling the meeting optimally under a given set of constraints which also includes the target audience. A typical scheduling task therefore is to, given a set of people among whom the meeting is to be arranged and their schedules, determine an “appropriate” time slot for the meeting. This set of people which is given as an input to the scheduler is usually fixed based on subscriptions, memberships, corporate hierarchy etc. or determined using personal communication. On the other hand in many significant scenarios the organizer of the meeting might only be aware of the agenda of the meeting, but not the people who are relevant to the meeting. In such cases the scheduling agent needs to first identify the set of people relevant to the meeting before fixing a suitable time-slot.

The current meeting scheduling methods require the meeting organizer to identify relevant people for a meeting. These methods have concentrated on various aspects of the general meeting scheduling problem with the assumption that the list of users involved in meeting is available to the system. PTIME has focused on user convenience, privacy, and trust and comfort factor. Various issues involved in large-scale deployment, scalable constraint reasoning and learning about user habits have also been studied. CMRadar provides end-to-end implementation of agent based calendaring system; primarily focusing on general architecture and communication language. Rcal system is a semantic web agent system, uses the Resource Description Framework (RDF) based representation of user calendar and provides the interoperability between web calendar and Microsoft's™ Outlook Schedules.

What is needed then is an intelligent topic based meeting scheduling system which automatically determines the users required/relevant to attend the meeting. The present invention has been developed to meet these needs in the art.

### SUMMARY OF THE INVENTION

The present invention discloses a method and system for scheduling topic based meetings. The method allows the organizer of the meeting to define the agenda for the meeting based on which the system intelligently assembles the set of users among whom the meeting should be scheduled. Once this set has been constructed, a regular scheduling algorithm is applied to arrange a meeting among the interested users. The scheduling process is distributed across various agents acting on behalf of the users among whom the meeting is arranged. Topic based meeting scheduler allows users with similar interests to schedule meetings based on common interests. The method and system of the present invention reduces the time in organizing the meeting among users required to attend, thus improving the efficiency of the group and allowing collaboration in an efficient manner.

In an embodiment of the present invention, a method for scheduling a topic based meeting is provided. The method includes the steps of receiving scheduling data for the meeting from an organizer, assembling a set of invitees relevant to a particular topic automatically. Assembling the set of invitees includes the steps of updating the users data from their personal information management agent to their user agent and storing the data in a user knowledge base, sending the scheduling data from the personal information management agent to a meeting scheduler agent, and computing a list of invitees based on the topic, user knowledge base and ontology. Scheduling the meeting among a set of interested invitees includes the following steps. The method requests the invitee-opinion from a set of user agents of the set of invitees relevant to the topic, interacts with the set of invitees, and sends the feedback on meeting from the set of user agents of the set of invitees to the meeting scheduler agent. The meeting scheduler agent sends a confirmation on the meeting to the organizer.

In another embodiment of the present invention, a topic based meeting scheduling system for scheduling a meeting among a set of users is provided. The system includes a personal information management agent for providing the interaction capability for the set of users to the meeting scheduling system, a set of user agents associated with the set of users for initiating the interaction with the set of users, a user profile agent for storing the profile of the set of users and for providing reasoning services to the system, a meeting scheduler agent for selecting an appropriate time slot for the meeting based on a set of scheduling policies defined by the organizer and, a set of communication channels for providing interfaces for the users to interact with the system. The user profile agent includes a knowledge base for storing the profile of the set of users; and a reasoning engine for providing description logic based reasoning services to the system.

The above summary of the present invention is not intended to describe each disclosed embodiment of the present invention. The figures and detailed description that follow provide additional aspects of the present invention.

### BRIEF DESCRIPTION OF DRAWINGS

The invention may be more completely understood in consideration of the following detailed description of various embodiments of the invention in connection with the accompanying drawings, in which:

FIG. 1 is a flow diagram illustrating the method for scheduling a topic based meeting according to an embodiment of the present invention.

FIG. 2 is a flow diagram illustrating an example of interaction between the agents while scheduling a topic based meeting according to an embodiment of the present invention.

FIG. 3 is a block diagram illustrating the components of the topic based meeting scheduling system according to an embodiment of the present invention.

FIG. 4 is a flow diagram illustrating an example of updating the user data in a user knowledge base according to an embodiment of the present invention.

### DETAILED DESCRIPTION OF DRAWINGS

In the following description, numerous specific details are set forth in order to provide a more thorough understanding of the present invention. However, it will be apparent to one skilled in the art that the present invention may be practiced without these specific details. In other instances, well-known features have not been described in detail in order to avoid obscuring the present invention.

The present invention discloses a method and a system for scheduling topic based meetings. The organizer of the meeting is allowed to define the agenda for the meeting based on which the system dynamically assemble the set of persons (users) among whom the meeting should be scheduled. Once this set has been constructed, a regular scheduling algorithm is applied to arrange a meeting among the interested users. Topic based meeting scheduler allows users with similar interests to schedule meetings based on common interests. Based on local inputs (per person list of interests) the scheduler generates a meeting and sends invitations to the users who may not even know each other but do cultivate common interests.

As examples, human resources departments could organize meetings among people willing to volunteer for some cause based on the people's interests. People interested in sports, for example, could decide to meet on a particular day of the week, subject to each other's availability, to discuss the football team selection. Based on user inputs or his interaction over the email, Instant Messenger (IM) etc., a set of topics can be suggested as possible topics of interest to the user. The user can then edit and update this suggested list to complete his list of topics of interest. This meeting scheduler is policy based and in case the policy demands so, can request user permission to modify his/her current schedule to accommodate the new meeting. In such cases the scheduler talks to the user via whichever communication channel (IM/electronic mail) the user is currently available on. The meeting scheduler may be implemented on a distributed multi agent framework using semantic web technology.

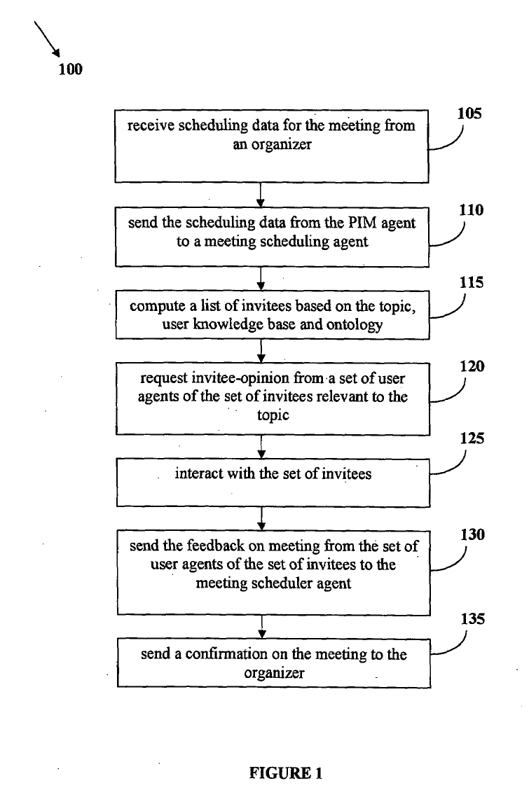

FIG. 1 is a flow diagram illustrating the method for scheduling a topic based meeting according to an embodiment of the present invention 100. A step 105 receives the scheduling data from an organizer. The organizer is allowed to define the agenda for the meeting based on which the set of invitees are dynamically assembled and among whom the meeting should be scheduled. The organizer defines the objective of the meeting, which is inputted to the system as the scheduling data. Another step 110 sends the scheduling data from the PIM agent to a meeting scheduler agent. Based on the schedules of the potential users (invitees) in the meeting, the scheduler agent attempts to find an appropriate time slot for the meeting. The scheduler agent takes into account the various scheduling policies defined by the user while negotiating for a suitable time slot for the meeting.

A step 115 computes a list of invitees based on the topic, user knowledge base and ontology. The computing is performed by the user profile agent. Another step 120 requests invitee-opinion from a set of user agents of the set of invitees relevant to the topic. A step 125 interacts with the set of invitees. This interaction is performed between the meeting scheduler agent, set of user agents of the set of invitees and the set of invitees. Another step 130 sends the feedback on meeting from the set of user agents of the set of invitees to the meeting scheduler agent. After sending the feedback on the meeting, the meeting scheduler agent sends a confirmation on the meeting to the organizer in a step 135.

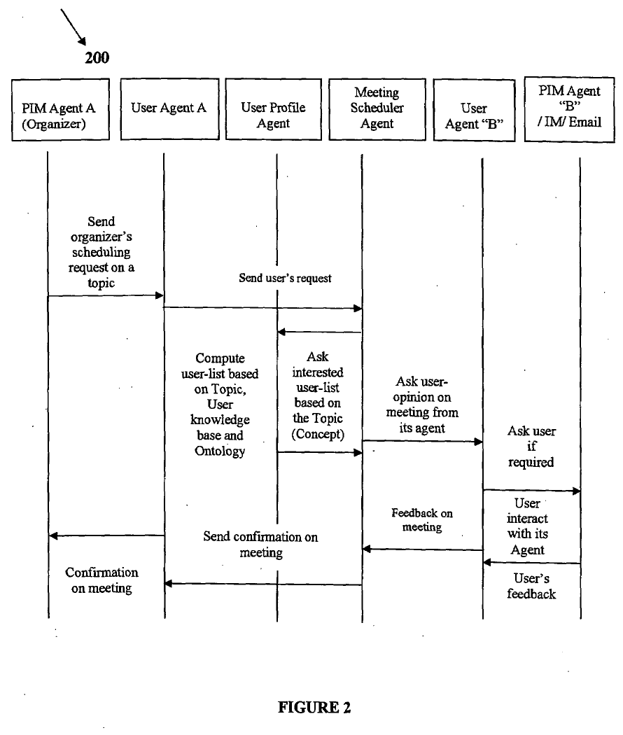

FIG. 2 is a flow diagram illustrating an example of interaction between the agents while scheduling a topic based meeting according to an embodiment of the present invention 200. Consider the example scenario as shown in FIG. 2, where user ‘B’ is interested in a meeting proposed by user ‘A’ (organizer). The PIM agent for the user ‘A’ updates the user details to the user agent ‘A’ and also sends the organizer's scheduling request to the user agent ‘A’. The user agent ‘A’ in turn sends the user details of user ‘A’ to a user profile agent. The user profile agent stores the user details of the user ‘A’ in a knowledge base. Then, the user agent ‘A’ sends the user request for scheduling the meeting to a meeting scheduler agent.

The meeting scheduler agent asks for interested user's-list (list of invitees) on the particular topic for the meeting as proposed by the organizer to the user profile agent. The user profile agent computes a user-list (list of invitees) based on topic, knowledgebase and ontology. This user-list is computed automatically using the knowledgebase and reasoning engine. Upon computing the user-list, the user profile agent sends the user-list to the meeting scheduler agent. The meeting scheduler agent asks the invitee-opinion on the meeting from its agent (in this case, user agent ‘B’). The user agent ‘B’ interacts with the PIM agent of user ‘B’ if required. The user ‘B’ sends the feedback on the meeting to the user agent ‘B’, and user agent ‘B’ in turn sends the feedback on meeting to the meeting scheduler agent. The meeting scheduler agent sends the confirmation on the meeting to the user agent ‘A’, and user agent ‘A’ in turn send the confirmation to the PIM agent ‘A’.

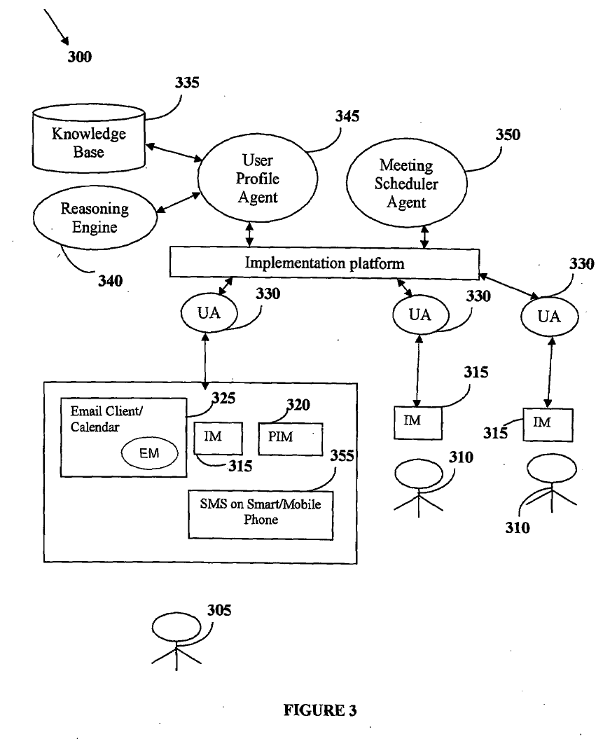

FIG. 3 is a block diagram illustrating the components of the topic based meeting scheduling system 300 according to an embodiment of the present invention. The system 300 includes an organizer 305, a set of invitees 310, a set of User Agents (UA) 330 associated with each users, a user profile agent 345, a meeting scheduler agent 350, a knowledge base 335, a reasoning engine 340 and a channel of interaction between user agents 330 and corresponding users. The channel of interaction includes electronic mail/calendar 325, IM 315 and PIM agent 320.

The PIM agent 320 provides the user interaction capability to the system 300. User inputs his/her profile details, requests various actions, and provides feedbacks on various scheduling scenarios using the PIM agent 320. The user agent 330 acts on the behalf of the user. It initiates interaction with user whenever required, otherwise, takes actions with the authority granted by the user. The user agent 330 also performs knowledge discovery on user's collaboration data. The user profile agent 345 stores the profile of each user and also provides reasoning services to other agents in the system 300. The user profile agent 345 builds up a knowledge base 335 from the information gathered from each user agent 330 and employs the reasoning engine 34Q to perform automated reasoning on the knowledge base 335. The knowledge base 335 and reasoning engine 340 are employed by the user profile agent 345 for providing various reasoning services. Reasoning engine 340 uses description logics based reasoning. As an example, one of the services offered by the user profile agent 345 is providing the list of users interested in a particular topic. The PIM Agent 320 and the user agent 330 populate its knowledge base for this particular task. These agents 320, 330 can either use a knowledge discovery process on user related data generated in collaboration environment (e.g. email, calendar 325, IM 315, workspace, file system) or take user inputs directly.

The meeting scheduler agent 350 attempts to find an appropriate time slot for the meeting based on the schedules of the potential participants in the meeting. The meeting scheduler agent 350 takes into account the various scheduling policies defined by the organizer 305 while negotiating for a suitable time slot for the meeting. For example the user's preferences can be requested by the agent to resolve meeting conflicts if the scheduling policy so demands. Various communication channels including PIM agent's 320 user interaction window, IM 315, electronic mails (E-mail) 325 are available for the agent to communicate with the user 305,310. E-mail 325, IM clients 315 and Short Message Services (SMS) on Smart/Mobile phones 355 are used as communication channels for obtaining user permissions to reschedule meetings. Additionally, these clients are also potential sources of knowledge regarding the user and his interests. Mining agents running on these clients, with user permission, provide the system 300 with valuable information regarding the user's preferences.

The system 300 provides support for the various meeting policies. These policies include “fixed” and “flexible” tags for meeting slots. The “flexible” policy is further subdivided into “can be shifted in this duration”, “priority” and “need user opinion”. The system 300 also assigns a “type” to meeting that may be used in determining the priority of the meeting and resolving the conflict with/without user intervention. The meeting types can be “general” (0), “personal” (1), “with juniors” (2), “with peers” (3), “with superior” (4) etc. and are calculated either intelligently with user profile details (e.g. management hierarchy profile ontology, project detail ontology) or with user assistance.

The user agent 330 intelligently determines the appropriate mode of communication with the user based on various factors. These factors are the presence of user on IM 315, user preference, corporate policy, priority and urgency of the meeting. Preferred medium for communication are the IM channel and PIM agent interaction channel. Other communication modes include E-mail and other PIM tools (e.g. Oracle Calendar).

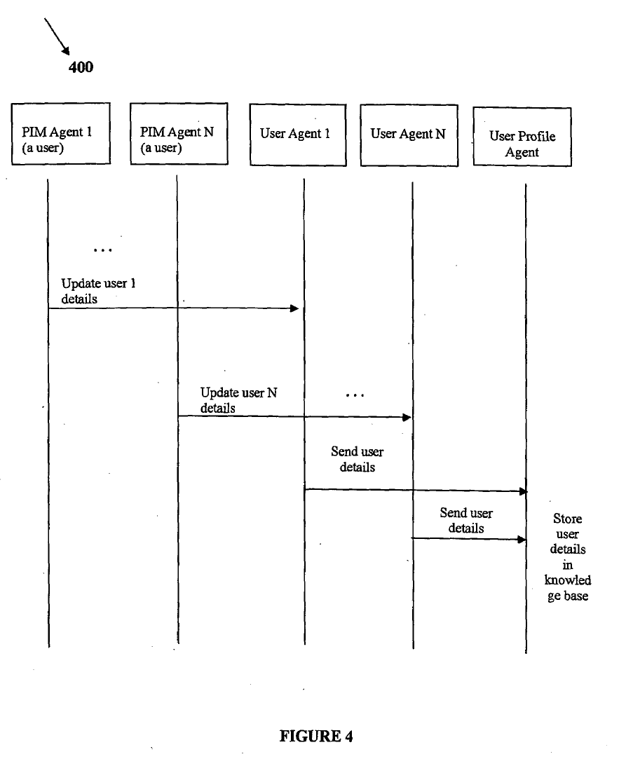

FIG. 4 is a flow diagram illustrating an example of updating the user data in a user knowledge base 400 according to an embodiment of the present invention. The figure shows updating the user details from the user's personal information management (PIM) agents (for a set of users (user 1 to user ‘N’)) to their respective user agents (user agent 1 to user agent ‘N’). This updated information includes the user details (interests, expertise, and role) about all users. This user details about all the users are updated in the user profile agent. The user profile agent stores the user details of the entire users in a knowledge base.

Foregoing described embodiments of the invention are provided as illustrations and descriptions. They are not intended to limit the invention to precise form described. Other variations and embodiments are possible in light of above teachings, and it is thus intended that the scope of invention not be limited by this detailed description, but rather by claims following.

1. A method for scheduling a topic based meeting comprising the steps of:
receiving scheduling data for said meeting from an organizer;
assembling a set of invitees relevant to a particular topic automatically, said set of invitees associated with a communication network;

2. The method of claim 1 further comprising:
scheduling the meeting among a set of interested invitees from said set of invitees.

3. The method of claim 1, wherein said receiving scheduling data comprises:
defining the objective and interests of the meeting, said defining is performed by said organizer.

4. The method of claim 1, wherein assembling a set of invitees comprises:
updating user data from the user's personal information management agent to a user agent and storing said user data for all users in a user knowledge base;
sending scheduling data from the personal information management agent to a meeting scheduler agent; and
computing a list of invitees based on the topic, user knowledge base and ontology, said computing is performed by said user profile agent.

5. The method of claim 2, wherein scheduling the meeting among a set of interested invitees comprises:
requesting invitee-opinion from a set of user agents of the set of invitees relevant to the topic;
interacting with the set of invitees, said interacting is performed between said meeting scheduler agent, said set of user agents of the set of invitees and the set of invitees;
sending the feedback on meeting from the set of user agents of the set of invitees to the meeting scheduler agent; and
sending a confirmation on the meeting to the organizer, said sending is performed by the meeting scheduler agent.

6. The method of claim 5, wherein said interacting with the set of invitees comprises interacting through a set of communication channels, said communication channels comprise instant messenger, electronic mail and short message services on smart/mobile phones.

7. A topic based meeting scheduling system for scheduling a meeting among a set of users comprising:
a personal information management agent for providing the interaction capability for said set of users to the meeting scheduling system, the set of users comprising an organizer and said set of invitees;
a set of user agents associated with the set of users for initiating the interaction with the set of users;
a user profile agent for storing the profile of the set of users and for providing reasoning services to the system;
a meeting scheduler agent for selecting an appropriate time slot for the meeting based on a set of scheduling policies defined by said organizer; and
a set of communication channels for providing interfaces for the users to interact with the system.

8. The topic based meeting scheduling system of claim 7, wherein said user profile agent comprises:
a knowledge base for storing the profile of the set of users; and
a reasoning engine for providing description logic based reasoning services to the system.

9. The topic based meeting scheduling system of claim 7, wherein said set of communication channels comprise instant messenger, electronic mail and short message services on smart/mobile phones.

10. The topic based meeting scheduling system of claim 9, wherein the user agent selects automatically the mode of communication and communication channels based on presence of users on instant messenger, user preference, corporate policy, priority and urgency of the meeting.

11. The topic based meeting scheduling system of claim 7, wherein the system supports a set of meeting policies, said meeting policies comprise fixed and flexible tags for the meeting time slots.
